(19) United States
(12) Patent Application Publication
(10) Pub. No.: US 2007/0223770 A1
(43) Pub. Date: Sep. 27, 2007

(54) Speaker

(75) Inventors: Koji Fujisawa, Nagoya-shi (JP); Yu Kobayashi, Kobe-shi (JP)

Correspondence Address: MESMER & DELEAULT, PLLC, 41 BROOK STREET, MANCHESTER, NH, 03104, US

(73) Assignees: SEVEN CO., LTD., Nagoya-shi (JP); SHARP SANGYO CO., LTD, Kobe-shi (JP)

(21) Appl. No.: 11/690,163

(22) Filed: Mar. 23, 2007

(30) Foreign Application Priority Data
Mar. 24, 2006 (JP) 2006-83028

(51) Int. Cl. H04R 25/00

(52) U.S. Cl. 381/396; 381/152

(57) ABSTRACT

A speaker includes a vibration board and at least one illuminant. The vibration board is made of translucent resin, and provided with light diffusing patterns on at least one side thereof. The illuminant is disposed behind the vibration board in a circular manner.

### CROSS-REFERENCE TO RELATED APPLICATIONS

This application claims the benefit of Japanese Patent Application No. 2006-83028 filed Mar. 24, 2006 in the Japan Patent Office, the disclosure of which is incorporated herein by reference.

### BACKGROUND OF THE INVENTION

(1) Field of the Invention

This invention relates to the technical field of speakers.

(2) Background Art

Some techniques have been introduced wherein the effect of electrical decoration is obtained by providing illuminants on a speaker. For example, Unexamined Japanese Patent Publication No. 2001-95074 discloses a speaker wherein light emitted from a light source is radiated on a center cap mounted on a center portion of a vibration board of the speaker, and the light is diffused by a dull finish or the like provided on the inner surface of the center cap.

However, in the above-described speaker, only the center portion of the speaker is illuminated. Therefore, the visual effect, which can be obtained by the above-described configuration, is limited.

### SUMMARY OF THE INVENTION

In one aspect of the present invention, a speaker includes a vibration board and at least one illuminant. The vibration board is made of a translucent resin, and provided with light diffusing patterns on at least one side thereof. The illuminant is disposed behind the vibration board in a circular manner.

In the above-described speaker, the illuminant is disposed behind the vibration board in a circular manner. Light emitted from the illuminant is diffused by the light diffusing patterns provided on the vibration board, and radiated therefrom. Therefore, the entire area of the vibration board can be used for providing the effect of luminous decoration.

Since the light emitted from the illuminant is diffused when the light passes through the vibration board, even the number of the light source is small, the entire surface of the vibration board can be illuminated.

For the vibration board, a sheet of translucent resin, such as polycarbonate, polyethylene, acryl, PET, or the like may be used. The translucency of the sheet may be completely transparent or may be semi-transparent. If the vibration board is completely transparent, the vibration board is brightly illuminated. If the vibration board is semi-transparent, the vibration board is softly illuminated. The translucent resin may be colored with dyes or pigments.

For the illuminant LED, inorganic EL, organic EL or the like may be used. Various lighting effect can be obtained by, for example, using a multi-color LED and changing the luminous color, or by using a plurality of illuminants and sequentially turning on and off the illuminants.

The disposition of the illuminant needs to be in a circular manner. However, if a plurality of illuminants is used, the interval between the illuminants is not limited to a specific interval. Alternatively, a circular EL may be used.

The position for disposing the illuminant may be anywhere behind the vibration board. However, it is preferable that the illuminant is disposed along a outer peripheral of a damper supporting a voice coil. More specifically, a frame of the speaker is provided with a circular flat portion so as to secure an outer edge of the damper, and thus provided with a suitable space outside of the damper for disposing the illuminant.

The light diffusing patterns may be provided by minute convexes or concaves. For instance, the light diffusing patterns may be formed with a number of linear convexes disposed in parallel, or in a grid manner. The light diffusing patterns may be formed with linear convexes disposed in a diagonal direction in addition to the linear convexes disposed in the grid manner. The light diffusing patterns may be formed with several basic patterns configured with circles, ovals, polygons (triangles, squares, hexagons etc.), or other shapes (star-shapes, diamond shapes etc.) concentrically disposed. The above-described patterns may be formed with linear concaves. Alternatively, the light diffusing patterns can be other patterns apart from the ones exemplified above.

In a case wherein the light diffusing patterns are formed with linear convexes or concaves, line density (the number of lines per unit length along a width direction of the convexes/concaves) are preferably equal to or higher than 1 line/mm (equal to or smaller than 1 mm pitch). The linear density may be, for example, 2 lines/mm (0.5 mm pitch), 4 lines/mm (0.25 mm pitch), 8 lines/mm (0.125 mm pitch), 10 lines/mm (0.1 mm pitch), and so on. The line density may be even higher.

Such light diffusing patterns may be provided by pressing the patterns on a sheet made of translucent resin.

The light diffusing patterns may be provided only on one side of the vibration board. Alternatively, the light diffusing patterns may be provided on both sides of the vibration board. If good audio effect is expected, the light diffusing patterns can be provided only on one side. If the light diffusing patterns are provided on both sides, optical feature in lighting effect can be improved.

In a case wherein the light diffusing patterns are provided on the both sides of the vibration board, equivalent patterns may be provided on the both sides. However, if each side of the vibration board is provided with a different type of patterns, diffusion manner in each side widely varies.

### BRIEF DESCRIPTION OF THE DRAWINGS

The invention will now be described below, by way of example, with reference to the accompanying drawings, in which:

FIGS. 1A to 1D are diagrams, in which 1A showing the front view of a speaker according to an embodiment of the present invention, in which 1B showing the sectional vertical view of the speaker, in which 1C showing the lateral view of the speaker, and in which 1D showing the rear view of the speaker;

FIG. 2 is a diagram showing a first example of light diffusing patterns provided on a vibration board of the speaker according to the embodiment;

FIG. 3 is a diagram showing a second example of light diffusing patterns provided on a vibration board of the speaker according to the embodiment;

FIG. 4 is a diagram showing a third example of light diffusing patterns provided on a vibration board of the speaker according to the embodiment;

FIGS. 5A to 5E are diagrams respectively showing an example of a shape of linear convexes provided on the vibration board and constituting the light diffusing patterns according to the present embodiment.

### DETAILED DESCRIPTION OF THE PREFERRED EMBODIMENT

First of all, it is to be noted that the present invention is not limited to the following embodiment, and that variations and modifications are possible within the scope of the invention.

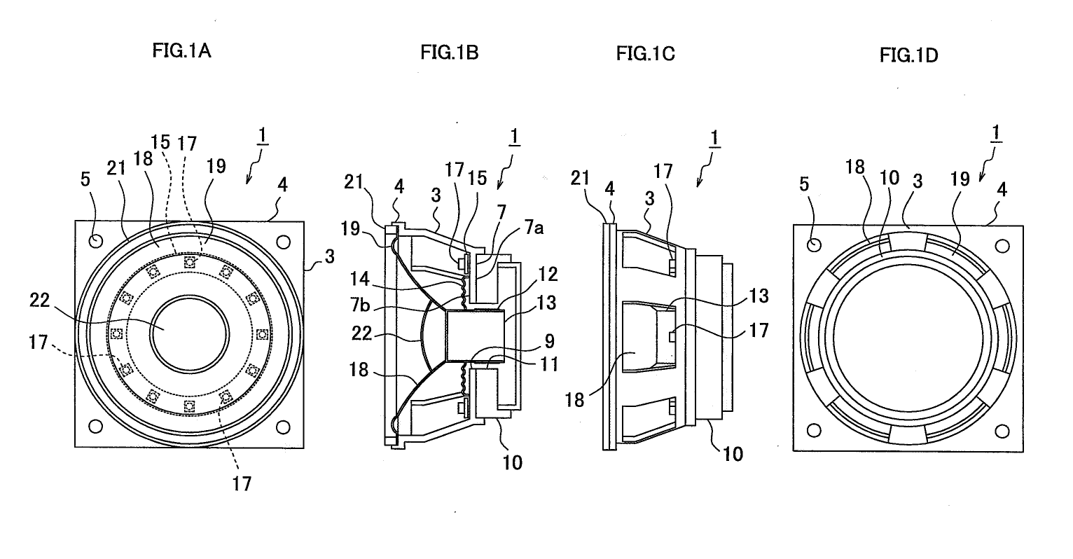

As shown in FIGS. 1A to 1D, a speaker 1 according to the present embodiment is configured such that respective portions of the speaker 1 are supported by a frame 3, which is the skeleton of the speaker 1. The frame 3 with is provided with a square flange 4 in the front end portion thereof. The flange 4 is provided with attachment holes 5. The speaker 1 can be secured to an application by using the attachment holes 5. The speaker 1 according to the present embodiment can be, for example, attached to a front frame of a game machine. However, the application of the speaker 1 is not limited to a game machine. The speaker 1 can be used for various applications.

A back wall 7 of the frame 3 is in a circular shape and provided with a wall hole 9. A Magnet 10 is attached to a back surface 7a of the back wall 7. A center hole 11 of the magnet 10 is concentric with the wall hole 9. As shown in FIG. 1B, the center hole 11 and the wall hole 9 are sequentially connected.

A bobbin 13 is provided so as to penetrate through the wall hole 9 and the center hole 11. Around the outer peripheral of the bobbin 13, a voice coil 12 is wound so as to face the inner peripheral of the magnet 10.

To the outer peripheral of the bobbin 13, an inner peripheral portion of a damper 14 is connected. An outer peripheral portion of the damper 14 is secured to a front surface 7b of the back wall 7. In other words, the bobbin 13 is supported by (the back wall 7) of the frame 3 via the damper 14. The bobbin 13 is disposed concentrically with the wall hole 9 of the back wall 7 and the center hole 11 of the magnet 10, but is not in contact with the inner peripherals of the back wall 7 and the magnet 10. The bobbin 13 can be displaced in the axial direction thereof.

On the front surface 7b of the back wall 7, a circular printed-circuit board 15 is attached along the outer peripheral of the damper 14. The printed-circuit board 15 is provided with a plurality (twelve, in the present embodiment) of multi-color LEDs 17 arranged thereon with uniform intervals.

To the front end of the bobbin 13, a rear end portion of a vibration board 18 is connected. The vibration board 18 is secured to the frame 3 in such a way that an outer peripheral portion of an edge 19 of the vibration board 18 is fixed to the frame 3 by a ring 21. A center cap 22 is attached inside of the vibration board 18 so as to cover the opening of the bobbin 13.

Due to the above-described configuration, when a signal current runs in the voice coil 12, the vibration board 18 is vibrated via the bobbin 13 around which the vice coil 12 is wound, and sound can be generated.

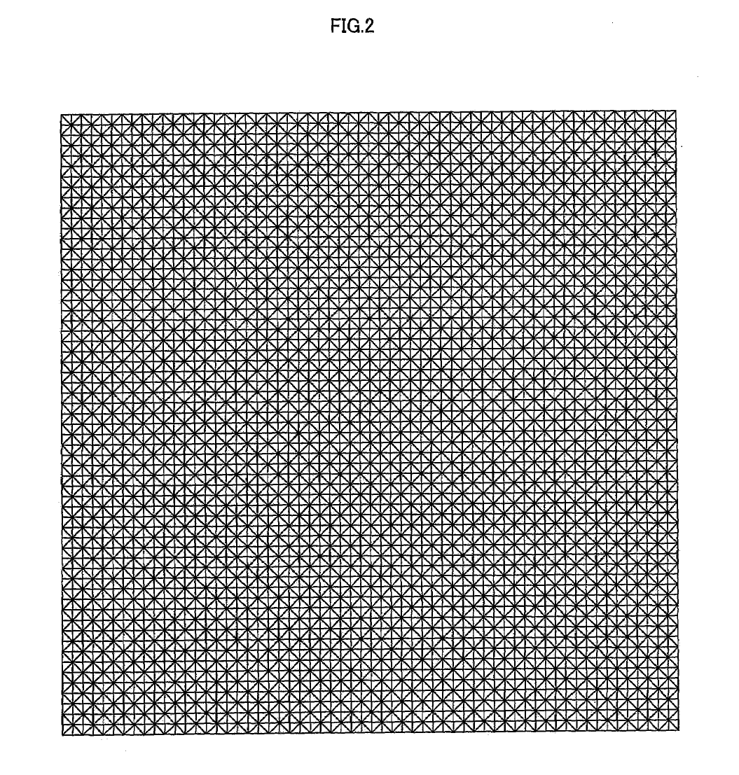

The vibration board 18 is made of a sheet of translucent resin, such as polycarbonate, polyethylene, acryl, PET, or the like, and formed into a cone shape. On one side or both sides of the translucent resin sheet, light diffusing patterns, exemplified in FIGS. 2 to 4, are provided.

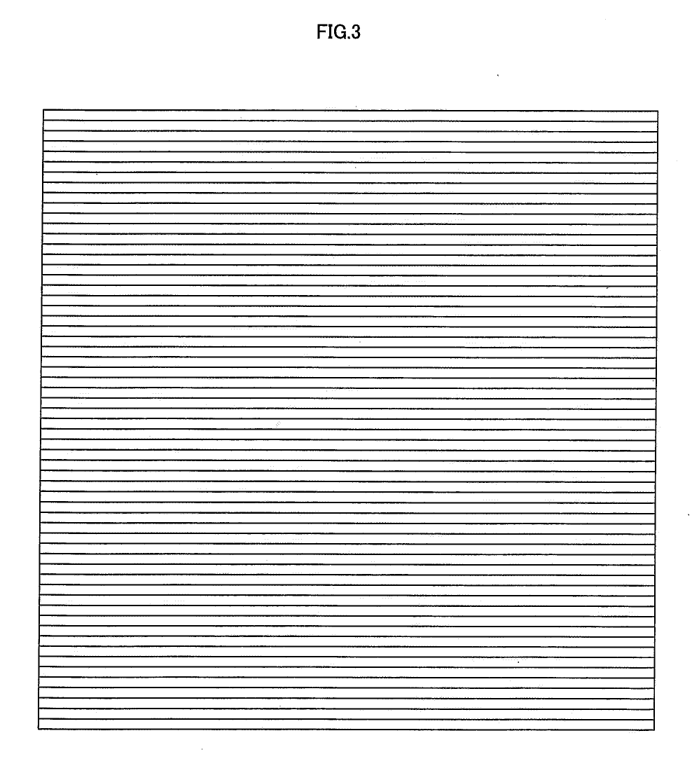

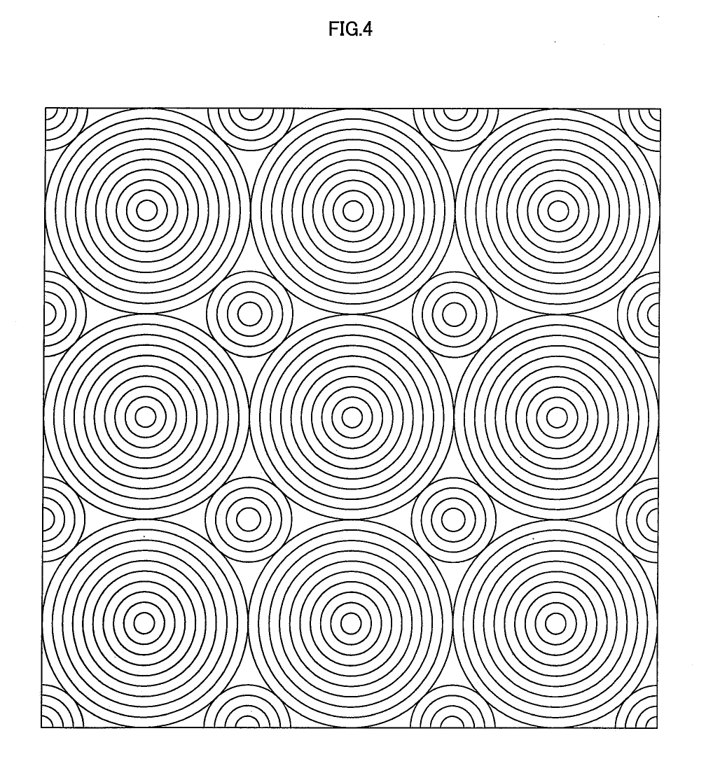

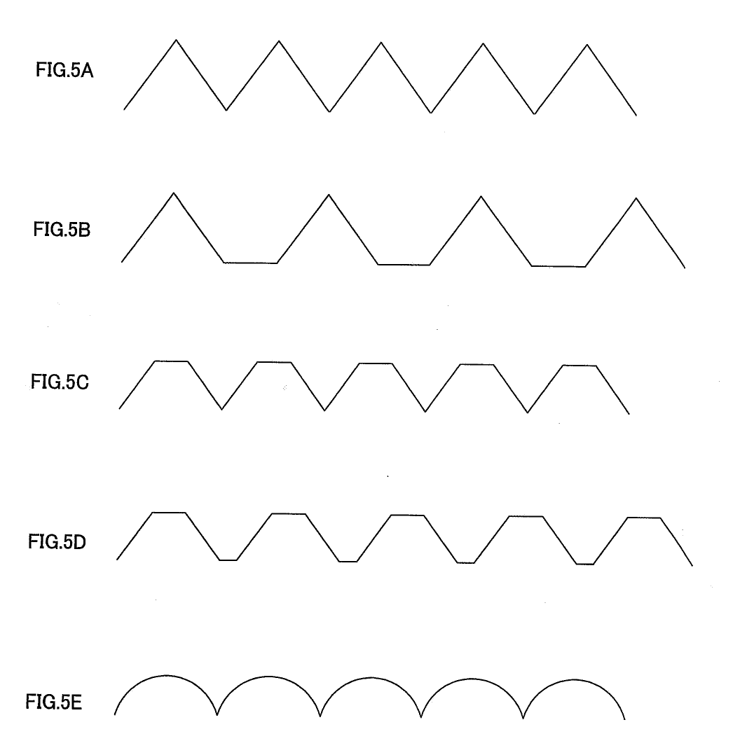

The light diffusing patterns shown in FIG. 2 are structured wherein linear convexes are disposed in a vertical, a horizontal, and an oblique directions, that is, in a grid manner. The light diffusing patterns shown in FIG. 3 are structured wherein linear convexes are disposed in a parallel direction. The light diffusing patterns shown in FIG. 4 are structured with several basic patterns wherein linear convexes are disposed so as to form various sizes of concentric circles. FIGS. 5A to 5E respectively show an example of the shape of the sectional surface of linear convexes constituting the light diffusing patterns. The sectional surface of linear convexes can be in triangle shapes (FIGS. 5A and 5B), in trapezoid shapes (FIGS. 5C and 5D), in an arc shape (FIG. 5E), and so on.

Therefore, when the multi-color LEDs 17 are illuminated, the light emitted therefrom is diffused by the light diffusing patterns provided on the vibration board 18, and radiated. As a result, the entire area of the vibration board 18 can be used for providing the effect of luminous decoration.

Since the vibration board 18 is made of a sheet with light diffusing patterns, and formed into a cone shape, distortion is generated in the light diffusing patterns when the vibration board 18 is formed. Due to the distortion, the patterns of light diffusion widely vary, as compared to a case wherein light is emitted to a flat sheet provided with light diffusing patterns. For example, the degree of brightness is different between the center portion (in the side of the bobbin 13) of the vibration board 18 and the outer peripheral portion (in the side of the edge 19) of the vibration board 18.

Because light emitted from the multi-color LEDs 17 is diffused when the light passes through the vibration board 18, even if the number if the multi-color LEDs 17 is small with respect to the size of the illuminated area of the vibration board 18, the entire surface of the vibration board 18 can be illuminated.

In addition, if the multi-color LEDs 17, disposed in a circular manner, are made to sequentially emit light in rotation, or to change the color of the light, the effect of diffusion can be changed, and various lighting effects become possible.

The multi-color LEDs 17 are disposed along the outer peripheral of the damper 14 supporting the voice coil 12. However, an additional space for providing the multi-color LEDs 17 (printed-circuit board 15) on the speaker 1 is not necessary, since a portion in the front surface 7b of the back wall 7 where the printed-circuit board 16 is disposed is not used in a conventional speaker. Therefore, the size of the speaker 1 does not become large.

What is claimed is:

1. A speaker comprising:
a vibration board made of translucent resin and provided with light diffusing patterns on at least one side thereof; and
at least one illuminant disposed behind the vibration board in a circular manner.

2. The speaker as set forth in claim 1 wherein the illuminant is disposed along an outer peripheral of a damper supporting a voice coil.

3. The speaker as set forth in claim 1 wherein a plurality of illuminants are disposed and provided with a uniform interval therebetween.

4. The speaker as set forth in claim 1 wherein the light diffusing patterns are provided on only one side of the vibration board.

5. The speaker as set forth in claim 1 wherein the light diffusing patterns are provided on both side of the vibration board.

6. The speaker as set forth in claim 1 wherein the light diffusing patterns are disposed in one of a gird, a parallel, and a concentric manners.

7. The speaker as set forth in claim 1 wherein the translucent resin forming the vibration board is selected a group of polycarbonate, polyethylene, acryl, and polyethylene terephthalate.
